(19) United States
(12) Patent Application Publication
(10) Pub. No.: US 2008/0053030 A1
(43) Pub. Date: Mar. 6, 2008

(54) Asymmetric retaining wall block

(75) Inventor: Raymond R. Price, Rochester, MN (US)

Correspondence Address: Patterson, Thuente, Skaar & Christensen, P.A., 4800 IDS Center, 80 South 8th Street, Minneapolis, MN, 55402-2100, US

(73) Assignee: Mortarless Technologies, LLC

(21) Appl. No.: 11/981,092

(22) Filed: Oct. 31, 2007

Related U.S. Application Data
(63) Continuation of application No. 10/836,512, filed on Apr. 30, 2004.

(51) Int. Cl. E04C 2/04; B28B 7/16

(52) U.S. Cl. 52/609; 249/52

(57) ABSTRACT

A method of manufacturing retaining wall blocks includes providing a mold and disposing a core in the mold. A dry casting concrete mixture is introduced into the mold around the core. The mixture is compressed with a movable shoe to form a casting comprising two retaining wall blocks joined together. The core is removed to form an aperture through the casting, the aperture defined by a wall surface. The formed casting is released from the mold and then split along a plane extending through the aperture to define two retaining wall blocks such that each block, on an outer surface thereof, has a groove defined by a portion of the wall surface of the aperture. Each groove can divide the front surface of the block into two asymmetric panels.

### RELATED APPLICATION

This application is a continuation of application Ser. No. 10/836,512 filed Apr. 30, 2004, which is hereby fully incorporated herein by reference.

### BACKGROUND OF THE INVENTION

Retaining walls are widely used in a variety of landscaping applications. Typically, they are used to maximize or create level areas and to reduce erosion and slumping. They may also be used in a purely decorative manner. In the past, retaining wall construction was labor intensive and often required the skills of trained trades people such as masons and carpenters. More recently, retaining wall construction has become significantly simplified with the introduction of self-aligning, modular, molded blocks of concrete that may be stacked in courses without the use of mortar or extensive training. With these types of blocks, it is possible to erect a retaining wall quickly and economically, and the finished product creates the impression and appearance of a conventional block and mortar retaining wall.

The facings of such blocks are typically formed with surfaces that create the impression that the block as been finished or split away from a larger body of stone. The facings can have split surfaces, faceted surfaces, smooth surfaces, planar surfaces, or be combinations thereof. Sometimes vertical channels are included on the facing to give the impression that there are two stones adjacent each other in a single course. However, a drawback with such channels is that they are usually clearly identifiable as such, especially when compared to vertical joints that are formed between adjacent blocks.

Another drawback with such blocks, is that only certain types of constructions are possible, such as vertically aligned walls or walls that may be rearwardly offset. In addition, such blocks are usually constrained to the particular pattern in which they may be arranged, for example, a running bond. Such prior art blocks are usually not available in different sizes nor is it possible to subdivide such blocks with consistent results.

### FIELD OF THE INVENTION

This invention relates generally to the construction of walls used in landscaping applications. More particularly, the present invention relates to a masonry block that can be used to build retaining walls.

### SUMMARY OF THE INVENTION

A method of manufacturing retaining wall blocks includes providing a mold and disposing a core in the mold. A dry casting concrete mixture is introduced into the mold around the core. The mixture is compressed with a movable shoe to form a casting comprising two retaining wall blocks joined together. The core is removed to form an aperture through the casting, the aperture defined by a wall surface. The formed casting is released from the mold and then split along a plane extending through the aperture to define two retaining wall blocks such that each block, on an outer surface thereof, has a groove defined by a portion of the wall surface of the aperture. Each groove can divide the front surface of the block into two asymmetric panels.

### BRIEF DESCRIPTION OF THE DRAWINGS

FIG. 1 is a front, perspective view of one embodiment of a block;

FIG. 2 is a side elevational, cross-sectional view of the block of FIG. 1;

FIG. 3 is a rear, perspective view of the block of FIG. 1;

FIG. 4 is a bottom plan view of the block of FIG. 1;

FIG. 5 is a partial, exploded, perspective view of the casting and the associated mold, divider plate, and core used to form it;

FIG. 6 is a top plan view of a casting of FIG. 5 that has been removed from its mold, and before it has been split into two blocks;

FIG. 7 is a partial, cross-sectional, side view of a preferred embodiment of a core used in the fabrication of the block of the preferred embodiment;

FIG. 8 is a bottom plan view of the core of FIG. 7;

FIG. 9 is a front, perspective, exploded view of the block of FIG. 1, after it has been split;

FIG. 10 is bottom plan view of an alternative embodiment of a block;

FIG. 11 is a side elevational, cross-sectional view of the block of FIG. 10;

FIG. 12 is a bottom plan view of another embodiment of a block;

FIG. 13 is a side elevational, cross-sectional view of the block of FIG. 12;

FIG. 14 is a front, perspective view of another embodiment of a block;

FIG. 15 is a side elevational, cross-sectional view of the block of FIG. 14;

FIG. 16 is a rear perspective view of the block of FIG. 14;

FIG. 17 is a front elevational view of a structure that may be formed by the blocks disclosed; and,

FIG. 18 side elevational view of a structure that may be formed by the blocks disclosed.

### DETAILED DESCRIPTION

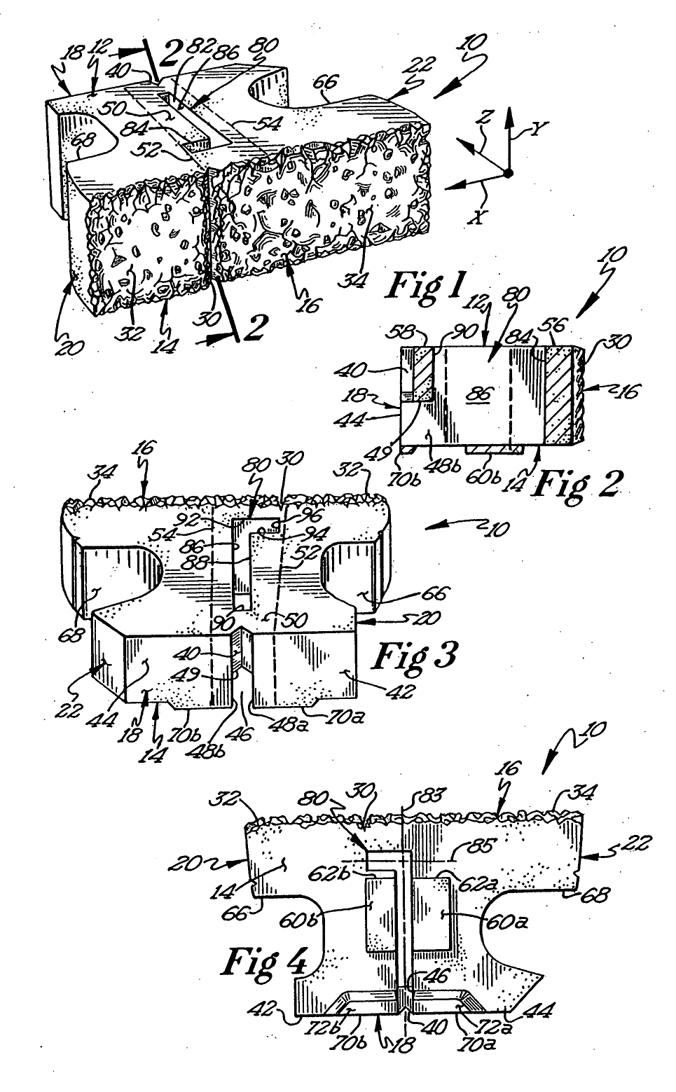

Turning to the figures wherein like parts are designated with like numerals throughout several views, the directions vertical and horizontal as used herein are made with reference to blocks in their normal position of use, eg. as in a wall, and wherein the dimensions of height, width, and depth correspond to the x, y, and z axes in a three dimensional coordinate system. With reference to FIG. 1 a preferred embodiment of a wall block 10 comprising a top surface 12, a bottom surface 14, a front surface 16, a rear surface 18 (see, FIGS. 2, 3, and 4), and first and second side surfaces 20, 22, respectively, is disclosed. The front surface 16, as depicted, includes a first groove 30 that extends vertically between the top and bottom surfaces, 12 and 14. The first groove 30 simulates a joint that is normally formed between the sides of adjacent blocks in a course of blocks. In forming the simulated joint, the first groove 30 divides the front surface or facing into two panels 32 and 34.

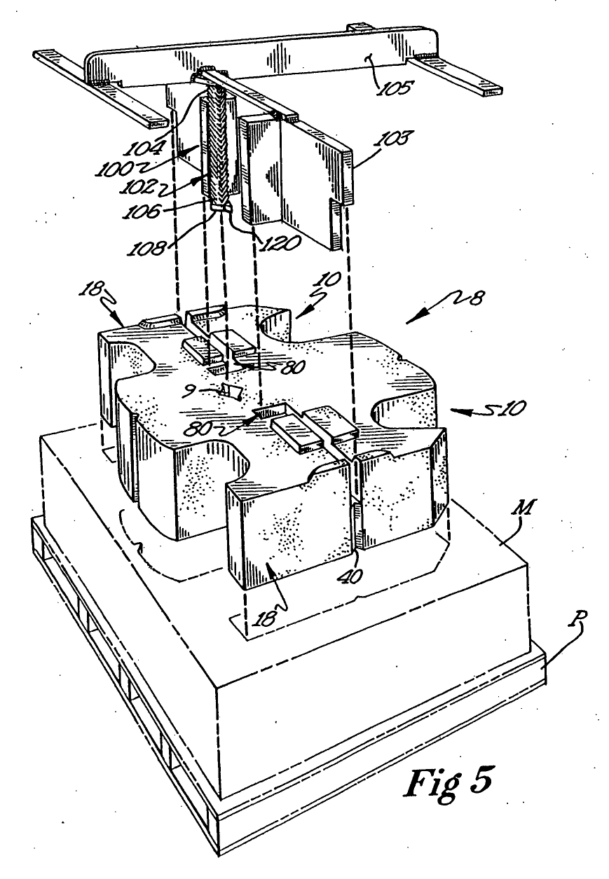

The block 10 also comprises a weakened section 50, indicated generally to be an area bounded by dashed lines 52, 54, which extends between the front surface 16 and the rear surface 18 along the depth (z-axis) of the block. As shown, the weakened section 50 includes a generally L-shaped opening 80 that extends along a portion of the top surface 12. In this preferred embodiment, the opening 80 of the weakened section 50 is formed by a first segment 82 and a second segment 84, which are in communication with each other, and which have longitudinal axes 83 and 85 that are angled with respect to each other (see, FIG. 4). The first segment 82 is generally defined by walls 86, 88, 90, and the second segment 84 is defined by walls 92, 94, and 96. It will be appreciated that the first and second segments need not be in communication with each other, and may be separate and distinct if desired. Moreover, it is understood that the opening could comprise more or less than two segments, which also may be separate and distinct.

A cross-sectional, side elevational view of the weakened section 50 is depicted in FIG. 2. Starting from the right side and moving towards the left, a portion of the weakened section includes the first groove 30 that begins at the front surface 16 and extends into the block body towards the rear surface 18 along the depth (z-axis) of the block. To the left of the first groove 30 is a web 56, whose rearward extent is defined by a wall 92 of the second segment 84. Continuing towards the left, wall 86 of the first segment 82 extends rearwardly until it reaches a second web 58, whose rear extent is defined by a second groove 40, and whose lower extent of the web is defined by an upper wall 49 of a notch 46 (see also, FIG. 3).

With reference to FIG. 3, the rear surface 18 of block 10 includes a second groove 40 that extends between the top surface of the block 12 and the upper wall 49 of notch 46. As with the first groove on the front surface, the second groove 40 divides the back surface 18 into two panels 42 and 44. And, as with the first groove, the second groove 40 is generally aligned with the opening 80 in splitting juxtaposition with respect thereto. The notch 46, generally defined by walls 48a, 48b, and 49, is in communication with opening 80, although it will be appreciated that they may be separate and distinct if desired. As will be understood, the blocks of this embodiment are configured and arranged so that a structure formed therefrom is able to resist forces exerted against the rear surface of the structure. This is achieved by providing the blocks with stop surfaces and projections.

As shown in FIGS. 3 and 4, stop surfaces 66, 68 are located at side surfaces 20, 22, between the front and rear surfaces of the block, while a pair of spaced apart projections 60a and 60b are located on the bottom surface 14 of the block. Each projection 60a, 60b includes a contacting surface 62a, 62b, and a non-contacting surface 64a, 64b, respectively. The contacting surfaces 62a, 62b are configured and arranged to engage the stop surfaces of a vertically adjacent course of blocks. The bottom surface 14 of the block also includes a pair of spaced apart positioning elements 70a and 70b. Each positioning element 70a, 70b includes a support surface 72a, 72b, respectively, which is configured and arranged to provide stability when a plurality of like blocks are stacked onto a pallet for shipping.

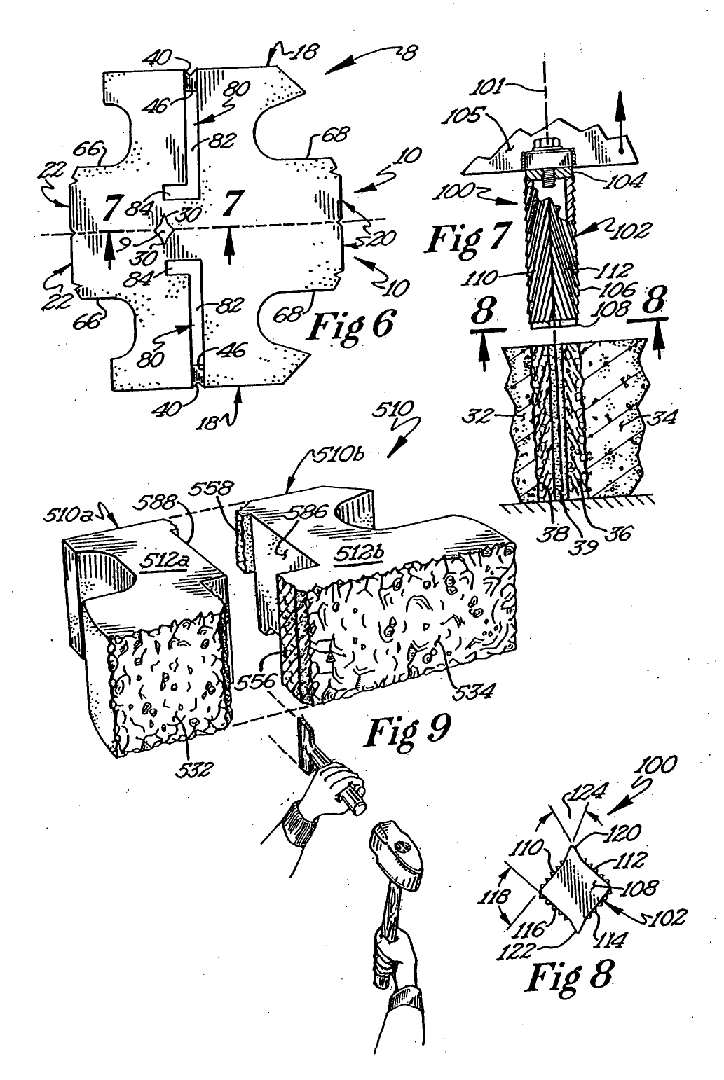

With reference to FIGS. 5-8, fabrication of the above-described embodiment will be discussed. While the block can be formed individually, it is advantageous to form two blocks from a larger casting 8 as shown in FIGS. 5 and 6. The casting may be either wet or dry, but dry casting is preferred. Generally, a dry casting is formed by introducing a mixture of cementitious material into a mold box and then compressing the mixture using a movable shoe. After compression, the block is removed from the mold, cured, and prepared for shipping and use. To fabricate blocks that have voids, through holes, hollows, etc., it is a common practice to provide the mold with cores and/or divider plates. The exploded, partial, view of FIG. 5 depicts the use of a core 100 and a divider plate 103, which may be attached to a support bar 105, which in turn may be attached to a mold box M that is positioned on a pallet P. Note that the mold box M and the pallet P are shown in phantom and do not constitute a part of this invention. Also, note that a movable shoe, which is normally used to compress the mixture and remove it from the mold box, has been omitted. After the casting 8 has been removed from the mold in which it was cast, it may be further processed by splitting into two individual blocks. FIG. 6 shows, in dashed line 7-7, where the casting may be split. Note the aperture 9, which is intersected by the splitting line. When the casting is split into two blocks, the aperture 9 is transformed into two grooves 30.

The aperture 9 is formed by a core 100, shown in FIGS. 7 and 8. As depicted, the core is generally elongated and has a longitudinal axis 101. Generally, the core 100 comprises a body 102 having a first end 104 and second end 106, with the core being configured and arrange so that it may modify and manipulate the block as it is being removed from the mold. In this regard, the core may take a variety of different forms and have different surface textures. Preferably, though, the body 102 has a generally polygonal cross-section with a plurality of similarly configured exterior sides. Although the sides are generally elongated and planar, it will be understood that they may assume other configurations without departing from the spirit and scope of the invention. For example, the sides may have an arcuate contour. Preferably, four sides are configured and arranged to form a core having a generally square cross section. However, it will be appreciated that the angles formed by the intersection of two of the sides may form an angle 118 having a range of about 30-150 degrees and the cross section of the core may appear more rhomboid-like.

Each side of the core may be provided with a textured surface, which is able to produce different surface textures in a block surface. Preferably, the sides may comprise a plurality of channels that are oriented so that they are angled with respect to the direction of removal of a block from a mold. This allows block material within the channels to be worked and redistributed over the surface of a block in churning and repacking motions. As can be seen in FIG. 7 the sides of the core form roughened portions 36 and 38 in the front surface a block as the core is separated from the block. As will be appreciated, the channels may also be varied cross-sectionally along their length, as well as with respect to each other. In addition, the channels may also vary in depth along their length. Although the channels are generally v-shaped, it is understood that other configurations are possible, for example, a u-shape, a squared notch shape, or a hemispherical shape. It is also understood, that the channels need not all have the same general cross-sectional profile. Thus one channel may be v-shaped and the next channel may be u-shaped, and the next channel may be yet another shape. Alternatively, it is envisioned that the sides of the core may be provided with a series of indentations and/or protrusions that churn, redistribute, and repack block material.

The core 100 may also include a base 108, which may be attached to the second end 106. Generally, the base 108 is configured so that it may also modify and manipulate the block as it is being removed from the mold. The base has at least two tines 120,122 that extend in opposite directions from the body 102 of the core 100 by a distance that is sufficient to enable the tines to modify and manipulate the block as it is being removed from the mold. Preferably, each tine is formed by two generally planar walls that form an angle 124 of about 30-150 degrees. And preferably, each tine extends beyond the body of the core by a distance of about ⅛ to about 1 inch (0.57 to 2.54 cm). As will be appreciated, the tines enable the core to form crevices 39 in front surfaces of blocks that create and accentuate shadows, and give the impression that there are two blocks instead of one block.

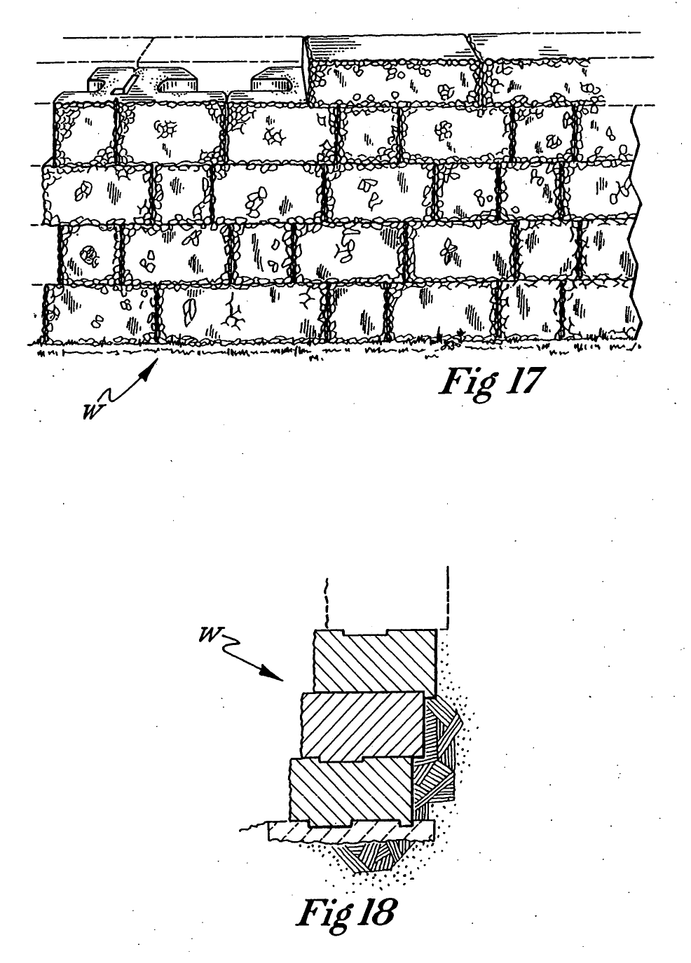

A block 510 that has been split into two smaller blocks 510a and 510b is depicted in FIG. 9. As can be seen, block 510a includes the front panel 532, while block 510b includes front panel 534. As will be appreciated each block 510a and 510b may have a corresponding projection, a positioning element, or both projection and positioning element as the case may be (see, for example, FIGS. 4, 10 and 15). A benefit of having the dual projections and positioning elements is that when a single block is split into two smaller blocks, each block will have the same ability to resist forces exerted against the rear surface of a structure as a whole block. Moreover, the user of such blocks will now be able to construct structures in a myriad of combinations (see, for example, FIG. 17). As will be understood, the blocks need not be split before they are assembled into a structure. They may be split in situ after a structure has been constructed.

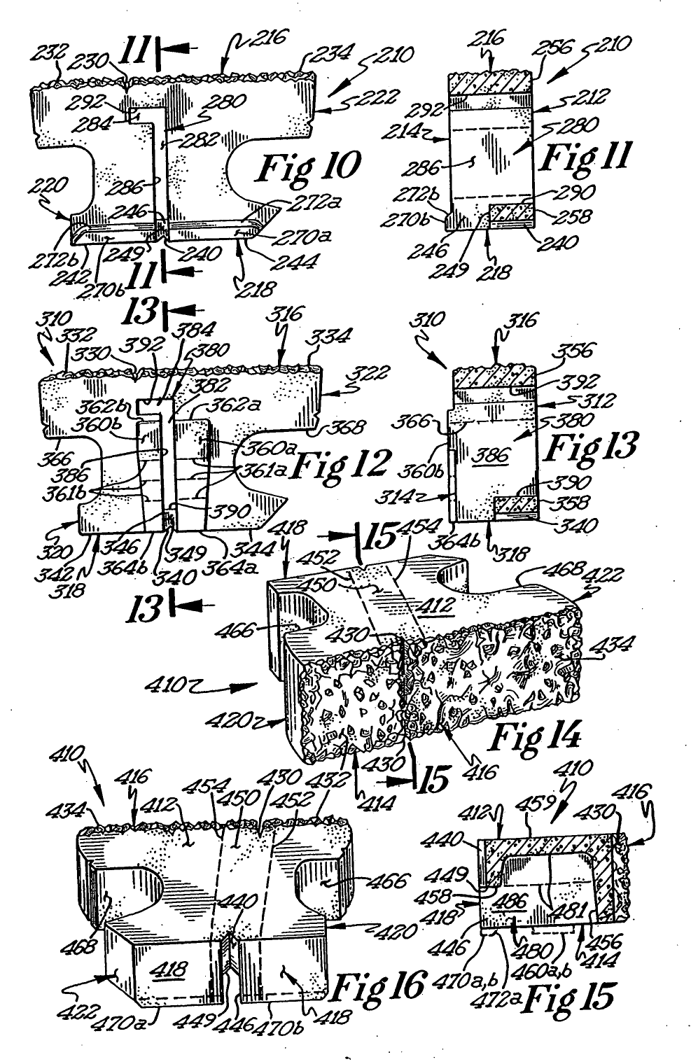

With reference to FIGS. 10 and 11 an alternative embodiment of a wall block 210 comprising a top surface 212, a bottom surface 214, a front surface 216, a rear surface 218, and first and second side surfaces 220, 222, respectively, is disclosed. As with the embodiment of FIG. 1, the front surface 216, includes a first groove 230 that extends vertically between the top and bottom surfaces, 212 and 214, and which simulates a joint that is normally formed between the sides of adjacent blocks. In forming the simulated joint, the first groove 230 separates the front surface or facing into two panels 232 and 234.

The block 210 also comprises a weakened section similar to the weakened section 50 of FIG. 1. However, for purposes of clarity, the dashed lines that indicate the general boundaries of the weakened section have been omitted, and it will be understood that the weakened section extends between the front surface 216 and the rear surface 218 along the depth (z-axis) of the block. As shown, the weakened section may comprise a generally L-shaped opening 280 that is formed by a first segment 282 and a second segment 284, which are in communication with each other.

The weakened section can be more clearly seen in FIG. 11, which has been rotated from its normal horizontal orientation to a vertical orientation. Starting from the top and moving towards the bottom, a portion of the weakened section comprises a web 256, whose forward extent is defined by a wall 292 of the second segment 284. Continuing down, wall 286 of the first segment 282 extends rearwardly until it reaches a second web 258, whose forward extent is defined by wall 290 of the first segment 282. As with the preferred embodiment of FIG. 1, the first and second segments 282 and 284 of this embodiment also extend between the top and bottom surfaces 212 and 214. Continuing down, the lowermost extent of web 258 is defined by a second groove 240, while the leftmost extent is defined by an upper wall 249 of a notch 246. The rear surface 218 of block 210 also includes a second groove 240 that forms two panels 242 and 244, and which extends between the top surface of the block 212 and the upper wall 249 of notch 246. As will be appreciated notch 246 may be in communication with the first segment 282 of opening 280, although not necessarily so.

As can be seen in FIG. 10, the bottom surface 214 of this embodiment does not have a pair of spaced apart projections. Rather, the bottom surface 214 of the block includes a pair of spaced apart positioning elements 270a and 270b, which are located adjacent the opposing walls of notch 246. Each positioning element 270a, 270b includes a contacting surface 272a, 272b, respectively, with the contacting surfaces configured and arranged to engage the rear surface of a vertically adjacent course of blocks. It will be appreciated that this embodiment enables wall structures having an upwardly receding slope or batter to be constructed. It will also be appreciated that with this embodiment, courses of blocks may not only be arranged in a traditional bonds such as a running bond, they may also be stacked in a generally columnar fashion as well.

With reference to FIGS. 12 and 13 another alternative embodiment of a wall block 310 comprising a top surface 312, a bottom surface 314, a front surface 316, a rear surface 318, and first and second side surfaces 320, 322, respectively, is disclosed. As with the embodiment of FIG. 1, the front surface 316, includes a first groove 330 that extends vertically between the top and bottom surfaces, 312 and 314, and which simulates a joint that is normally formed between the sides of adjacent blocks. In forming the simulated joint, the first groove 330 separates the front surface or facing into two panels 332 and 334.

The block 310 also comprises a weakened section similar to the weakened section 50 of FIG. 1. However, for purposes of clarity, the dashed lines that indicate the general boundaries of the weakened section have been omitted, and it will be understood that the weakened section extends between the front surface 316 and the rear surface 318 along the depth (z-axis) of the block. As shown, the weakened section includes a generally L-shaped opening 380 that is formed by a first segment 382 and a second segment 384, which are in communication with each other.

The weakened section can be more clearly seen in FIG. 13, which has been rotated from its normal horizontal orientation to a vertical orientation. Starting from the top and moving towards the bottom, a portion of the weakened section comprises a web 356, whose extent is defined by a wall of the second segment 384. Continuing down, wall 386 of the first segment 382 extends downwardly until it reaches a second web 358. As with the preferred embodiment of FIG. 1, the first and second segments 382 and 384 of this embodiment also extend between the top and bottom surfaces 312 and 314. Continuing down, the lowermost extent of web 358 is defined by a second groove 340, while the leftmost extent is defined by an upper wall 349 of a notch 346. The rear surface 318 of block 310 also includes a second groove 340 that forms two panels 342 and 344, and which extends between the top surface 312 of the block and the upper wall 349 of notch 346. As will be appreciated notch 346 may be in communication with the first segment 382 of opening 380, though not necessarily so.

As can be seen in FIG. 13, the bottom surface 314 of this embodiment does not have a pair of spaced apart positioning elements. Rather, the bottom surface 314 of block 310 includes a pair of spaced apart projections 360a and 360b, which are located adjacent the opposing walls of first segment 382, and which may also be located adjacent the opposing walls of notch 246 as well. Each projection 360a, 360b includes a contacting surface 362a, 362b, and a non-contacting surface 364a, 364b, respectively. The contacting surfaces 362a, 362b are configured and arranged to engage the stop surfaces 366, 368 of a vertically adjacent course of blocks. As shown, the distance between the contacting and non-contacting surfaces of the projections can vary from a point spaced from the front surface 316 to the back surface 318. This variable distance has a range of about 1-8 inches (2.54 to 20.32 cm), which is about 10 to 75 percent of the depth of the block. Examples of the variable distances are shown in dashed lines 361a and 361b. It will be appreciated that the location of the contacting surfaces 362a and 362b may also be varied along the depth of the block, which would allow the blocks to be arranged in vertical or stepped courses (see, FIGS. 17 and 18).

With reference to FIGS. 14-16 an alternative embodiment of a wall block 410 comprising a top surface 412, a bottom surface 414, a front surface 416, a rear surface 418, and first and second side surfaces 420, 422, having stop surfaces 466, and 468, respectively, is disclosed. As with the embodiment of FIG. 1, the front surface 416, includes a first groove 430 that extends vertically between the top and bottom surfaces, 412 and 414, and which simulates a joint that is normally formed between the sides of adjacent blocks. In forming the simulated joint, the first groove 430 separates the front surface or facing into two panels 432 and 434.

The block 410 also comprises a weakened section 450, indicated generally to be an area within dashed lines 452, 454, and which extends between the front surface 416 and the rear surface 418 along the depth (z-axis) of the block. Like the weakened section of the previously described embodiments, the weakened section 450 of this embodiment is a generally L-shaped opening that extends between the front 416 and rear 418 surfaces along the depth direction or z-axis in a three dimensional coordinate system. In this preferred embodiment, however, the opening does not extend through the top surface 412 of the block. Rather, the opening has a variable vertical extent that is indicated by solid and dashed lines 481 (see, FIG. 15).

The weakened section 450 can be more clearly seen in FIG. 15. Starting from the right side and moving towards the left, a portion of the weakened section includes the groove 430 that begins at the front surface 416 and extends along the depth or z-axis in a three dimensional coordinate system towards the rear surface of the block. At the point of termination of the groove 430 there begins a web 456, whose extent is defined by a wall of the second segment 484. Continuing towards the left, wall 486 of the opening extends rearwardly until it reaches a second web 458. Note, in this embodiment, the opening 480 does not extend to the top surface. Rather, the opening has a vertical extent 481 that is variable in height. Continuing to the left, the rear extent of web 458 is defined by a second groove 440, while the lower extent is defined by an upper wall 449 of a notch 446.

With reference to FIG. 16, the rear surface 418 of the block includes a second groove 440 that forms two panels 442 and 444, and which extends between the top surface 412 of the block and the upper wall 449 of notch 446. Since the structure of the notch as been described above, it will not be discussed here in detail. The block 410 may also include a pair of spaced apart projections 460a and 460b, a pair of spaced apart positioning elements 470a and 470b, or a combination of projections and positioning elements (see also, FIG. 15). It will be understood that if this embodiment is provided with projections, the primary point of engagement between vertically adjacent blocks will be stop surfaces 466 and 488 of sides surfaces 420 and 422. It will also be understood that if this embodiment is provided with only positioning elements, the point of engagement between vertically adjacent blocks will be at the rear surface 418 (see, for example, FIG. 18).

In use, the block may be used to construct a vertical, free standing wall or a retaining wall having an upwardly receding slope, or batter as shown in FIGS. 17 and 18, respectively. Generally, each type of structure depicted may be assembled by first laying a first course of blocks to form a base layer. Then, additional courses of blocks are added, preferably by setting the front end of a block on the rear portion of the course below and then sliding the block forwardly along the depth direction (z-axis) until the block comes into engagement with the lower course of blocks. It will be understood that the point of engagement between vertically adjacent blocks will depend upon whether the block is provided with projections or positioning elements.

After a wall has been constructed, the blocks in the wall may be split into smaller blocks, if desired. This may be accomplished by initiating a fracture along the front groove, which is in splitting juxtaposition relative to the weakened section. As one will appreciate, the fracture will travel along the weakened section of the block towards the rear surface. Because the blocks in the structure are usually constrained by adjacent blocks, the resulting fracture will be rather small, but significant.

Examples of wall structures that may be constructed with the blocks disclosed are depicted in FIGS. 17 and 18. FIG. 17 is a wall W in which the blocks are vertically aligned. As shown, the first four courses are composed of blocks disclosed herein. The top course comprises capstones and does not form part of the invention. Although the blocks are depicted as having roughened front surfaces or facings, it will be appreciated that other textures for the front surface are possible. FIG. 18 shows a side elevational representation in which various embodiments of the blocks described above may be used to form a retaining wall having an upward receding slope or batter.

The present invention having thus been described, other modifications, alterations or substitutions may present themselves to those skilled in the art, all of which are within the spirit and scope of the present invention. It is therefore intended that the present invention be limited in scope only by the claims attached below:

What is claimed is:

1. A method of manufacturing retaining wall blocks, comprising:
providing a mold;
disposing a core in the mold;
introducing a dry casting concrete mixture into the mold around the core;
compressing the mixture with a movable shoe to form a casting comprising two retaining wall blocks joined together;
removing the core to form an aperture through the casting, the aperture defined by a wall surface;
releasing the formed casting from the mold; and
splitting the casting along a plane extending through the aperture to define two retaining wall blocks such that each block, on an outer surface thereof, has a groove defined by a portion of the wall surface of the aperture.

2. The method of claim 1, further comprising shifting the core prior to the step of removing the core to define a texture on the wall surface of the aperture.

3. The method of claim 1, further comprising providing the core with a generally polygonal cross-section.

4. The method of claim 1, further comprising providing the core with a generally square cross-section.

5. The method of claim 1, further comprising providing the core with a plurality of channels that are angled with respect to a direction of removal of the casting from the mold box.

6. The method of claim 1, further comprising providing the core with a base including at least two tines configured to form crevices in the casting.

7. The method of claim 6, wherein each tine is formed by two generally planar walls situated at an angle of between 30 and 150 degrees relative to each other.

8. A concrete casting for splitting into two separate retaining wall blocks, the casting comprising:
a body defined by a first end spaced apart from a second end, a pair of spaced apart side surfaces, a top surface and an opposing bottom surface, the body defining an aperture extending through the block body from the top surface to the bottom surface, each of the side surfaces defining a notch extending in a direction between the top surface and the bottom surface, the notches disposed such that a substantially vertical splitting plane extending between the notches intersects the aperture;
a first projection located between the splitting plane and the first end, the projection having a stop surface and a non-contacting surface; and
a second projection located between the splitting plane and the second end, the projection having a stop surface and a non-contacting surface.

9. The casting of claim 8, wherein the aperture in the casting body has a generally polygonal cross-section.

10. The casting of claim 8, wherein the aperture in the casting body is offset from a lateral midpoint of the splitting plane.

11. The casting of claim 8, wherein the aperture in the casting body is defined by a plurality of textured inner surfaces.

12. The casting of claim 8, further comprising a notch defined in the first end and the second end, each notch extending vertically between the top surface and the bottom surface.

13. The casting of claim 8, wherein the casting is asymmetrical relative to a plane extending between the notches in the first end and the second end.

14. The casting of claim 8, wherein the casting is symmetrical relative to the splitting plane.

15. A block suitable for use in constructing a wall, the block comprising:
spaced apart top and bottom surfaces defining the height of the block;
a front surface extending in a direction between the top and bottom surfaces;
a rear surface spaced from the front surface by a distance defining the depth of the block;
a first side surface located between the top and bottom surfaces and between the front and rear surfaces, the first side surface including a stop surface;
a second side surface spaced from the first side surface, the second side surface located between the top and bottom surfaces and between the front and rear surfaces, the second side surface including a stop surface;
a projection extending outwardly from the bottom surface, the projection including a contacting surface configured and arranged to engage a stop surface of a vertically adjacent pair of blocks;
wherein the front surface of the block defines a first generally vertical notch extending between the top surface and the bottom surface that divides the front surface into two asymmetric panels.

16. The block of claim 15, wherein the first generally vertical notch simulates a joint formed between sides of adjacent blocks in a course of blocks.

17. The block of claim 15, wherein the rear surface defines a second generally vertical notch extending between the top surface and the bottom surface.

18. The block of claim 15, wherein the stop surfaces are substantially parallel to the front surface.

19. The block of claim 15, wherein the contacting and stop surfaces of the block are offset from each other by a predetermined distance with respect to the front surface of the block.

20. The block of claim 15, wherein the contacting and stop surfaces of an adjacent course of blocks serve to position the front surface of a block in one course of blocks in a predetermined relation with a block in an adjacent course as the contacting and stop surfaces of an adjacent course of blocks are brought into registry with each other.
